(19) United States
(12) Patent Application Publication
(10) Pub. No.: US 2024/0302399 A1
(43) Pub. Date: Sep. 12, 2024

(54) SAMPLE HOLDER SHUTTLE

(71) Applicant: Covaris, LLC, Woburn, MA (US)

(72) Inventors: Edward Ognibene, Belmont, MA (US); James A. Laugharn, JR., Boston, MA (US); Paul Prokop, Woburn, MA (US); Andrew Briggs, Medford, MA (US); Todd Anthony Basque, West Newbury, MA (US)

(73) Assignee: Covaris, LLC, Woburn, MA (US)

(21) Appl. No.: 18/595,773

(22) Filed: Mar. 5, 2024

Related U.S. Application Data
(60) Provisional application No. 63/450,209, filed on Mar. 6, 2023.

(51) Int. Cl. G01N 35/04; B01L 9/06

(52) U.S. Cl. CPC G01N 35/04; B01L 9/06; G01N 2035/0418

(57) ABSTRACT

A sample holder shuttle for holding a sample holders for laboratory processing, such as PCR thermal cycling, focused acoustic energy treatment and others. Sample holders can be received at openings of the shuttle such that a plurality of sample holders can be held by the shuttle and moved or otherwise manipulated simultaneously. A cover can engage with sample holders, e.g., to press the sample holders downwardly into contact with the shuttle.

### RELATED APPLICATIONS

This application is a Non-Provisional application claiming priority under 35 U.S.C. § 119(e) to U.S. Application Ser. No. 63/450,209, filed Mar. 6, 2023. The entire contents of this application are incorporated herein by reference in its entirety.

### BACKGROUND

### 1. Field of Invention

Methods and apparatus for sample holders, such as a shuttle to hold and move multiple sample tubes simultaneously.

### 2. Related Art

Sample holders, including individual tubes or vessels, as well as vessels in multi-well plates, sometimes called microtiter plates or microplates, are widely used in laboratory and other applications for holding and processing liquid samples, e.g., for diagnostic testing and research. Such vessels are used to expose a sample to a variety of different treatments, including exposure to sonic energy, heat/cooling cycles such as that used in PCR processing, and others.

### SUMMARY

In some embodiments, a sample holder shuttle for holding one or more sample holders for laboratory processing includes a plate with a plurality of openings each configured to receive and hold a respective sample holder such that a lower portion of the sample holder depends or protrudes from a bottom side of the plate, e.g., such that the lower portion is exposed for receiving acoustic, thermal or other energy to treat a sample in the sample holder. In some embodiments, the plate may be flat or planar and/or may have first and second opposed edges and third and fourth opposed edges, e.g., the plate may have a rectangular shape. In some cases, first and second gripper walls may extend from the plate, e.g., the gripper walls may extend upwardly from a top side of the plate at first and second opposed edges, respectively. The first and second gripper walls may be configured to engage with a robotic gripper or other automated handler and support the plate and sample holders received at the plurality of openings. For example, the gripper walls may be configured so a robotic gripper can pick up the shuttle and associated sample holders and move or otherwise manipulate the shuttle and the sample holders in a desired way, e.g., between laboratory treatment stations in an automated sample material processing system. In some embodiments, the sample holder shuttle may include a machine readable feature, such as an RFID tag or barcode, configured to identify a source, compatibility or other feature of the shuttle and/or sample holders held by the shuttle. Such features may aid in automated tracking and processing of sample materials held by the shuttle. In some cases, the plate may include a notch extending inwardly from an edge of the plate, e.g., a first notch may extend inwardly from the third edge of the plate. In some embodiments, the notch may be configured to align a cover with respect to the plate and/or to align the plate with respect to another component.

In some embodiments, the plurality of openings may be configured in a symmetrical rectangular array, e.g., in an 8 by 12, 4 by 6, 6 by 8 or other rectangular array commonly used for sample tubes or other sample holders in laboratory processing. In some cases, the openings may be configured in any regular or irregular array or arrangement. In some examples, the plurality of openings may be configured to engage with a rim of a sample holder such that portions of the sample holder below the rim hang or depend from the plate. In some embodiments, a portion of the sidewall of a sample holder (e.g., the sidewall of a tube) may engage with the plate at a respective opening so the sample holder is supported by the plate and a lower portion of the sample holder hangs below the plate. For example, a plurality of sample holders may each be configured as a tube with a lower portion and an upper portion, with the upper portion configured to engage with a part of the plate near a respective one of the plurality of openings to support the tube such that the lower portion depends or protrudes from the plate. Arranging the tubes to depend or protrude from the plate may expose the tubes for receiving various treatment conditions, such as receiving acoustic and/or thermal energy to treat a sample material held in the tube. In some cases, engagement of the sample holder with the plate at the openings may orient the sample holder in a desired way relative to the plate, e.g., in directions along a plane of the plate (e.g., in X and Y directions) as well as in directions transverse to the plane of the plate (e.g., in a Z direction). For example, sample holders may have a longitudinal axis along which the sample holder extends, and engagement of the sample holder with the opening may orient the longitudinal axis to be perpendicular to a plane of the plate.

In some embodiments, the first and second gripper walls may each include gripping surfaces configured to engage with a robotic gripper or other automated handler that face outwardly and away from the plate. For example, the gripping surfaces may be perpendicular to a plane of the plate and/or may include gripping surfaces with an anti-slip feature configured to engage with the robotic gripper. An anti-slip feature may include a surface roughness, a resilient pad or other element, and/or groove. In some cases, the gripper walls may be configured so a robotic gripper can clamp onto the gripper walls by exerting force on the walls in an inward direction toward a center of the plate.

In some cases, a notch on the plate may have surfaces that are parallel to one or more other edges of the plate. For example, a notch that extends inwardly from a third edge of the plate may have surfaces that are parallel to the first and second edges of the plate. This may assist the notch in orienting edges of the plate relative to another component, such as a cover or tube rack.

In some cases, a cover may be configured to extend over at least a portion of the plate to cover the plurality of openings and/or sample holders held by the shuttle. In some embodiments, the cover may include an alignment feature configured to engage with the shuttle and/or sample holders to orient the cover with respect to the shuttle. For example, an alignment feature on the cover may engage with a notch of the plate to align the cover with the plate. In some examples, the plate may include first and second notches and the cover may include first and second alignment features configured to engage with a respective one of the first and second notches to align the cover with the plate. For example, the first and second alignment features may each include a wedge including opposed sides arranged at an angle relative to each other and configured to engage with a corresponding surface of the respective notch. The first and second notches may each have surfaces that are parallel to edges of the plate and may be configured to engage with a respective side of a respective one of the wedges, e.g., to align the cover with respect to the edges of the plate.

In some cases, a cover may be configured to extend over at least a portion of plate to cover the plurality of openings and/or sample holders held by the shuttle, and the cover may be configured to press downwardly on one or more sample holders received at the plurality of openings. For example, the cover may be configured to be supported relative to the plate by the one or more sample holders, and the cover may be configured to have a mass sufficient to urge the one or more sample holders into engagement with the plate. The engagement force may help keep the sample holders engaged with the shuttle and/or orient the one or more sample holders relative to the plate. In some embodiments, the one or more sample holders may include a radially extending flange that is positioned on the plate adjacent the opening in which the sample holder is received, and a force of the cover on the one or more sample holders may urge the flange into contact with the plate to orient the sample holder relative to the plate.

In some embodiments, a plurality of sample holders may each be configured as a tube with a lower portion and an upper portion. The upper portion may be configured to engage with a part of the plate of a shuttle near a respective one of the plurality of openings to support the tube such that the lower portion depends from the plate. A cover may be configured to engage with each of the plurality of sample holders to urge the plurality of sample holders into contact with the plate. In some cases, each of the plurality of sample holders may include a cap covering an opening at the upper portion of the sample holder, and the cover may be configured to engage with the cap to urge the sample holder into contact with the plate. In some embodiments, each cap may include a recess and the cover may include a plurality of protrusion each configured to engage with the recess of a corresponding cap of a sample holder. Engagement of the protrusions with a respective cap may orient the cover relative to the shuttle and/or orient the sample holders relative to the shuttle and/or may help engage the sample holders with the plate of the shuttle.

In some cases, a plurality of sample holders may each be configured as a tube with a lower portion, an upper portion and an internal volume extending from an opening at the upper portion to the lower portion. The upper portion may be configured to engage with a part of the plate of a shuttle near a respective one of the plurality of openings to support the tube such that the lower portion depends from the plate, and the plurality of sample holders may be configured to hold a sample in the internal volume for treatment by focused acoustic energy.

In some cases, openings of a plate of a shuttle may receive a respective sample holder so that the sample holder is relatively easily removed from the opening, e.g., by lifting the sample holder from the shuttle. In some embodiments, openings of a shuttle may each be configured to engage with a sample holder received at the opening to lock the sample holder in place relative to the shuttle. For example, the openings may be configured to engage with the sample holder to prevent rotation about and/or movement along a longitudinal axis of the sample holder relative to the shuttle. Such engagement may aid in automated capping/decapping of sample holders or otherwise ensuring sample holders are not separated from a shuttle.

In some embodiments, a sample holder assembly for holding one or more sample holders for laboratory processing is provided. The assembly can include a shuttle having a plate including a plurality of openings each configured to receive and hold a respective sample holder such that a lower portion of the sample holder depends from a bottom side of the plate and is exposed for receiving acoustic energy to treat a sample in the sample holder. The assembly and/or shuttle can have any one or more of the features described above or otherwise herein and may include those one or more features in any suitable combination. For example, the shuttle may have openings configured to lock sample holders relative to the shuttle (or not), may have gripper walls (or not), may have a cover alignment notch (or not), and so on. The assembly may include a cover (or not) having any of the features described, such as a mass and configuration to urge sample holders into contact with the shuttle, etc.

Other advantages and novel features of the invention will become apparent from the following detailed description of various non-limiting embodiments when considered in conjunction with the accompanying figures and claims.

### BRIEF DESCRIPTION OF THE DRAWINGS

Aspects of the invention are described with reference to the following drawings in which numerals reference like elements, and wherein:

FIG. 1 is perspective view of a sample holder shuttle and associated sample holders and cover in an illustrative embodiment;

FIG. 2 is a side view of a sample holder shuttle and associated sample holders and cover positioned above an acoustic energy treatment device for treating sample material in the sample holders to acoustic energy;

FIG. 3 shows a top perspective view of an alternative cover positioned over a plurality of sample holders held by a sample holder shuttle in another illustrative embodiment;

FIG. 4 is a bottom perspective view of the cover of FIG. 3 illustrating protrusions at a bottom of the cover to engage with sample holders;

FIG. 5 is a top perspective view of a sample holder rack for use with a sample holder shuttle and sample holders held by the shuttle in an illustrative embodiment;

FIG. 6 shows an end view of a plurality of sample holders held by a sample holder shuttle and the sample holder rack of FIG. 5;

FIG. 7 shows a top view of a sample holder shuttle having openings configured to engage with sample holders in an illustrative embodiment;

FIG. 8 shows a top perspective view of the sample holder shuttle of FIG. 7;

FIG. 9 shows a top view of a sample holder shuttle having openings configured to engage with sample holders in another illustrative embodiment;

FIG. 10 shows a top view of a sample holder shuttle having openings configured to engage with sample holders in yet another illustrative embodiment; and

FIG. 11 shows a top view of a sample holder shuttle having openings configured to engage with sample holders in still another illustrative embodiment.

### DETAILED DESCRIPTION

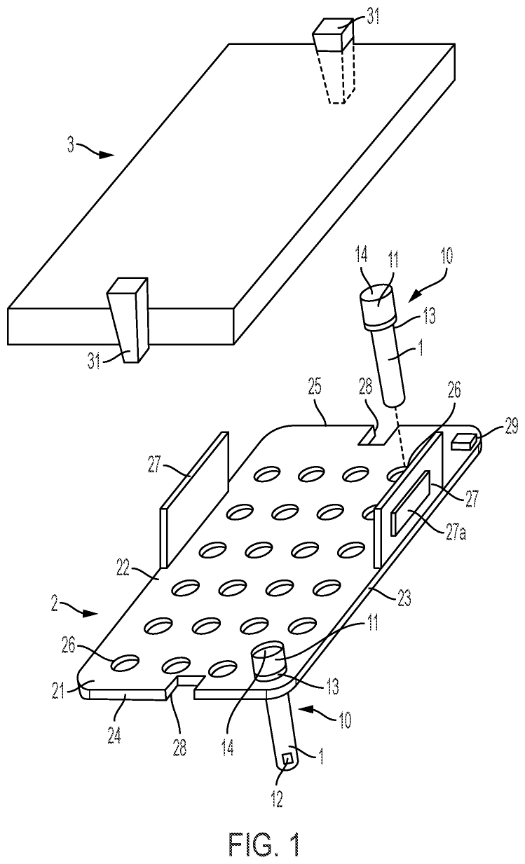

FIG. 1 shows an illustrative embodiment of a sample holder shuttle 2 and associated sample holders 10 and cover 3. The shuttle 2 is configured to hold one or more sample holders 10 and move the sample holders 10 between locations, such as different locations at which sample material in the holders 10 is subjected to one or more treatment processes. Examples of such processes include, but are not limited to, treatment with focused acoustic energy or other sonication, thermocycling or other temperature modification, storage, incubation, pipetting, capping/decapping, etc. The sample holders 10 can be configured in any suitable way, e.g., including a vessel 1 having a rim 13 and defining an opening at an upper end of the vessel 1 to an interior volume where sample material 12 may be held. The sample material 12 may be any suitable liquid, solid, semi-solid and/or combination of such components and may include bone or other tissue, leaves, seeds or other plant material, blood, or any other biological material that may be subjected to one or more laboratory processes and analysis. The sample holders 10 may include a cap 11 to cover the opening to the interior volume of the vessel 1, e.g., the cap 11 may seal the interior volume closed from an external environment. The cap 11 may engage the vessel 1 by threaded engagement, interference fit, welding, etc., and thus the vessel 1 may include a thread or other engagement feature to engage with a cap 11 at an inner and/or outer surface of the vessel wall. In some embodiments, caps 11 may include a recess 14, e.g., including a fin, rib, notch or other feature to aid in automated capping/decapping. For example, a robotic or other tool may be configured to engage with a cap 11, e.g., at an engagement feature in the recess 14 or other portion of the cap 11, to rotate the cap 11 relative to the vessel 1 to threadedly engage the cap 11 and vessel 1 and/or place the cap 11 on or remove the cap 11 from the vessel 1. The cap 11 and/or vessel 1 can include a gasket such as an o-ring or other feature to aid sealing the opening of the vessel 1 closed, e.g., to isolate sample material 12 in the vessel from environmental conditions outside of the vessel 1. In some cases, the vessel 1 can include a sidewall that extends from the rim 13 to a bottom of the vessel 1, which may be rounded, square, etc. The vessel 1 may be made of any suitable material, such as polypropylene, polymethylpentene or polycarbonate materials to provide a vessel with good suitability for use in thermal cycling treatment (e.g., as used in PCR processing or other thermal applications) and/or focused acoustic energy treatment, such as is done with Covaris acoustic treatment instruments (Covaris, Woburn Ma.), or other sonication processes. However, a vessel 1 can be made of any single or combination of materials such as polymethylpentene, polycarbonate, polypropylene, Low Density Polyethylene (LDP), High Density Polyethylene (HDP), Liquid Crystal Polymer (LCP), Cyclic Olefin Copolymer (COC), and/or Cyclic Olefin Polymer (COP) materials (or others) that provide a desired performance for acoustic energy treatment or other processing conditions.

The shuttle 2 can include a plate 21 including first and second opposed edges 22, 23 and third and fourth opposed edges 24, 25. In some cases, the plate 21 may define a rectangular shape, although other shapes are possible such as trapezoidal and other polygonal, circular, oval, irregular, etc. shapes, and the plate 21 can be made of any suitable material such as metal, plastic, composites, thermoset materials, etc. The plate 21 may be planar, e.g., a top surface of the plate 21 may lie in a single plane, and may include a plurality of openings 26 each configured to receive and hold a respective sample holder 10 such that a lower portion of the sample holder depends from a bottom side of the plate 21 and is exposed, e.g., for receiving acoustic energy to treat a sample in the sample holder 10. The openings 26 may be arranged in a regular, rectangular array, e.g., an 8 by 12 array, or in any other suitable regular or irregular arrangement. The openings 26 may be sized and/or shaped to locate a corresponding sample holder 10 in directions parallel and/or perpendicular to a plane of the plate 21, e.g., so that a sample material 12 is accurately located for exposure to a focal zone of acoustic energy. For example, the sample holder vessels 1 may have a circular cross sectional shape and the openings 26 may have a size and/or shape to closely fit or otherwise suitably fit the vessel 1 and position the vessels 1 in a desired way in one or more directions (e.g., orthogonal directions) along an upper plane of the plate 21. In some cases, sample holders 10 may have a rim 13 or other feature that engages with the plate 21 so that the sample holder 10 is suitably positioned or otherwise oriented relative to the plate 21. For example, a rim 13 of a vessel 1 may have a lower surface that is perpendicular to a longitudinal axis of the vessel 1 (e.g., perpendicular to a longitudinal axis of a cylindrical shape of the vessel). The rim 13 may contact the upper surface of the plate 21 around the opening 26 in which the vessel 1 is positioned so that the vessel 1 extends from the plate 21 in a desired way, e.g., depends perpendicularly from the plate 21. Suitable positioning of vessels 1 relative to the plate 21 may be useful, e.g., so that the vessels 1 and sample material 12 are properly positioned for exposure to a focal zone of acoustic energy (e.g., in the form of a circular spot or line) or other treatment.

The shuttle 2 can include first and second gripper walls 27 extending upwardly from the plate 21, e.g., at or near the first and second opposed edges 22, 23, respectively. The first and second gripper walls 27 may be configured to engage with a robotic gripper or other device so that the sample holders 10 held by the shuttle 2 can be picked up, moved and/or placed in a desired way. Thus, the gripper walls 27 can support the plate 21 and sample holders 10 received at the plurality of openings 26 for any suitable movement. The gripper walls 27 can each have gripping surfaces configured to engage with the robotic gripper or other device that face outwardly and away from the plate 21, e.g., so a robotic gripper can exert an inwardly directed clamping force on the walls 27. Alternately, or additionally, the gripper walls 27 can have gripping surfaces arranged in other ways, such as surfaces that face downwardly and toward the plate 21, that face inwardly and parallel to a plane of the plate 21, that are defined by holes or grooves in the walls 27, etc. In some cases, the gripper walls 27 can each include gripping surfaces including an anti-slip feature 27a configured to engage with the robotic gripper, such as a suitable surface roughness, a resilient pad, or one or more grooves. The gripper walls 27 can extend along all or part of an edge 22, 23, and may extend upwardly relative to the plate 21 to any suitable extent. In some cases, the gripper walls 27 may be centered along a respective edge 22, 23. Gripper walls 27 may include a single wall element and/or multiple wall elements that are separated from each other by one or more gaps.

In some cases, a cover 3 may be configured to extend over at least a portion of the plate 21 to cover at least some of the openings 26 and/or sample holders 10 held by the shuttle 2. In some cases, a cover 3 may help cover openings of vessels 1 held by the shuttle 2, e.g., where openings of the vessels 1 are not covered by a cap 11. Alternately, or in addition, the cover 3 may cover caps 11 of sample holders 10, e.g., to help prevent deposition of foreign materials on the caps 11 and/or plate 21 and/or to help keep sample holders 10 held suitably in place on the shuttle 2. In some cases, the shuttle 2 and/or cover 3 may include an alignment feature to help properly position the cover 3 relative to the shuttle 2. For example, the cover 3 may include one or more alignment features 31 configured to engage with a corresponding notch 28 or other alignment feature on the shuttle 2 to align the cover 3 with the plate 21. In some cases, the cover can include first and second alignment features 31 configured to engage with a respective one of first and second notches 28 to align the cover 3 with the plate 21. Each of the alignment features 31 may include a wedge including opposed sides arranged at an angle relative to each other and configured to engage with a corresponding surface of the respective notch 28. In some cases, the notches 28 may each have surfaces that are parallel to the first and second edges 22, 23 of the plate 21 and may be configured to engage with a respective side of a respective one of the wedges. Thus, if the cover 3 is lowered onto the shuttle 2 so that a leading or lowermost end of the wedges 31 are positioned in a notch 28, the wedges 31 and notches 28 may interact so that the cover 3 is suitably aligned relative to the shuttle 2 as the cover 3 is lowered onto the shuttle 2. Other alignment features are possible, including conical engagement features on the cover and shuttle, alignment pins, and so on. A machine readable feature 29 on the shuttle 2, such as an RFID tag, barcode, alphanumeric text, etc., may be provided to identify a source of the shuttle or a compatibility of the shuttle. For example, a treatment apparatus intended to be used to treat sample material 12 held by sample holders 10 on a shuttle 2 may read the machine readable feature 29 to ensure that the shuttle 2 and the associated sample holders 10 are suitable for use with the treatment apparatus and/or to help keep track of a location of shuttles/sample holders and processing of sample material 12 in the sample holders 10. This may be employed as part of an automated sample tracking and treatment process that tracks the movement and treatment progress for sample holders 10 and shuttles 2 as they move through a multi-step laboratory process. In some cases, sample holders 10 may also include machine readable features which may be read so that sample holders 10 can be associated with a particular shuttle 2, e.g., so that the sample holders 10 can be tracked in their movement and processing without having to read each individual sample holder 10 after the sample holder 10 has been associated with a shuttle 10.

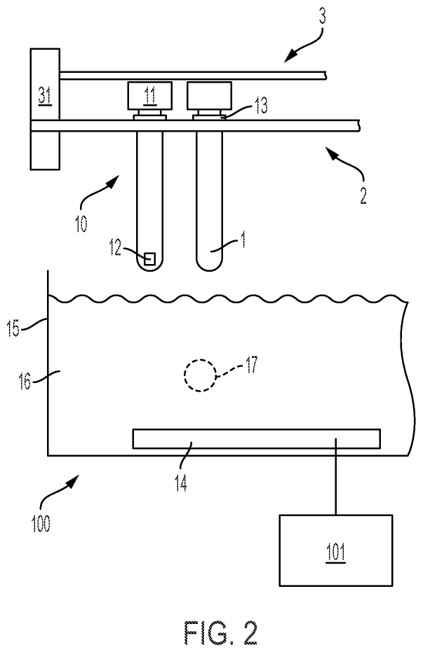

FIG. 2 shows a side view of the shuttle 2 and cover 3 of FIG. 1 along with two sample holders 10 held by the shuttle 2. In some embodiments, the cover 3 can be positioned to extend over the shuttle 2 to cover at least some openings 26 of the shuttle 2 and sample holders 10 held by the shuttle 2. The cover 3 may be configured to press downwardly on one or more sample holders 10 received at openings 26, e.g., to orient sample holders 10 relative to the plate 21. For example, the cover 3 may contact caps 11 or other portions of the sample holders 10 to press downwardly on the sample holders 10. This downward force or force on the sample holders 10 directed toward the plate 21 may help keep the sample holders 10 engaged with the shuttle 2. In some cases, the cover 3 may be configured to have a mass sufficient to urge the sample holders 10 into engagement with the plate 21, e.g., to orient the sample holders 10 relative to the plate 21. For example, the sample holders 10 may each include a radially extending flange or other portion that is positioned on or otherwise contacts the plate 21 adjacent the opening 26 in which the sample holder 10 is received. The force of the cover 3 on the sample holders 10 may urge the flange or other sample holder portion into contact with the plate 21 to orient the sample holder 10 relative to the plate 21. In some cases, force of the cover 3 on the sample holders 10 may cause the sample holder vessels 1 to depend from the plate 21 such that a longitudinal axis of the vessels 1 is perpendicular or otherwise suitably oriented relative to the plate 21 or a plane of the plate 21. Suitably orienting the sample holders 10 may aid in suitably positioning the vessels 1 and sample material 12 for treatment.

For example, FIG. 2 shows a schematic diagram of an acoustic treatment system 100 that may be used to treat sample material 12 held by sample holders 10 on a shuttle 2. In some embodiments, the acoustic treatment system 100 includes an acoustic energy source with an acoustic transducer 14 (e.g., including one or more piezoelectric elements) that is capable of generating an acoustic field (e.g., at a focal zone 17) suitable to cause mixing, e.g., caused by cavitation, and/or other effects on a sample contained in a vessel 1. Vessels 1 held by a shuttle 2 may be lowered from the position shown in FIG. 2 so that at least a portion of the vessels 1 is located in contact with a coupling medium 16 of the acoustic treatment system 100. Acoustic energy may be transmitted from the transducer 14 to the vessels 1 through the coupling medium 16, such as a liquid (e.g., water), a gel or other semi-solid, or a solid, such as a silica, metal or other material. Thus, the transducer 14 may be spaced from the vessels 1 and can transmit acoustic energy from outside the vessel volume for transmission into the vessel 1 via the coupling medium 16. Where the coupling medium 16 is a liquid, a coupling medium container 15 may be used to hold the coupling medium 16. Suitable positioning of the sample holders 10 relative to the shuttle 2 may help ensure that the vessels 1 and sample material are positioned in a known location relative to an acoustic field, for example, at least partially within a focal zone 17 of acoustic energy. Although FIG. 2 illustrates a focal zone 17 having a spherical shape, it is possible to generate a line-shaped focal zone, e.g., that spans across multiple vessels 1 held by the shuttle 2 to treat multiple samples simultaneously, or to generate multiple focal zones 17. A system control circuit 101 may control various functions of the system 100 including operation of the acoustic transducer 14, positioning of the shuttle 2 and vessel 1 held by the shuttle 2, receiving operator input (such as commands for system operation), outputting information (e.g., to a visible display screen, indicator lights, sample treatment status information in electronic data form, and so on), and others. Thus, the system control circuit 101 may include any suitable components to perform desired control, communication and/or other functions. For example, the system control circuit 101 may include one or more general purpose computers, a network of computers, one or more microprocessors, etc. for performing data processing functions, one or more memories for storing data and/or operating instructions (e.g., including volatile and/or non-volatile memories such as optical disks and disk drives, semiconductor memory, magnetic tape or disk memories, and so on), communication buses or other communication devices for wired or wireless communication (e.g., including various wires, switches, connectors, Ethernet communication devices, WLAN communication devices, and so on), software or other computer-executable instructions (e.g., including instructions for carrying out functions related to controlling a load current control circuit for the transducer 14 and other components), a power supply or other power source (such as a plug for mating with an electrical outlet, batteries, transformers, etc.), relays and/or other switching devices, mechanical linkages, one or more sensors or data input devices (such as a sensor to detect a temperature and/or presence of the medium 16, a video camera or other imaging device to capture and analyze image information regarding the vessel 1 or other components, position sensors to indicate positions of the acoustic transducer 14 and/or the vessel 1, and so on), user data input devices (such as buttons, dials, knobs, a keyboard, a touch screen or other), information display devices (such as an LCD display, indicator lights, a printer, etc.), and/or other components for providing desired input/output and control functions. U.S. Pat. Nos. 6,948,843 and 6,719,449 are incorporated by reference herein for details regarding the construction and operation of an acoustic transducer and its control.

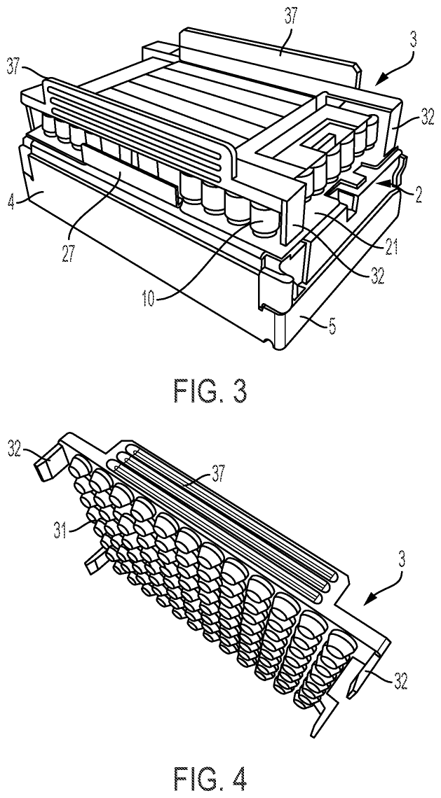

FIG. 3 shows another illustrative arrangement for a cover 3 for use with a sample holder shuttle 2 and associated sample holders 10. In some embodiments, the cover 3 may include gripper walls 37, e.g., in a way similar to that provided for the shuttle 2. This can allow the cover 3 to be moved by a robotic gripper or other automated device, e.g., so that the cover 3 can be placed on a shuttle 2, e.g., to help hold sample holders 10 in place, and/or removed from a shuttle 2, e.g., to allow placement and/or removal of sample holders from the shuttle 2. In some cases, the cover 3 can include legs 32 or other features to help define a distance between a lower side of the cover 3 and sample holders 10, help support the cover 3 on the shuttle 2 and/or to allow the cover 3 to be placed on a surface away from the shuttle 2 while avoiding contact of the lower side of the cover 3 with the surface. This can help reduce a risk of potential contamination of sample material since the cover 3 may be less likely to pick up and deposit foreign material on the sample holders 10 and/or the shuttle 2. Also, if less than all of the openings 26 of a shuttle 2 have a sample holder 10 received, the legs 32 can also help maintain a desired distance between and orientation of the cover 3 relative to the shuttle 2. For example, if only a few sample holders 10 are received at one end of a shuttle 2, the cover 3 may contact the sample holders 10 but otherwise the cover 3 may not be supported relative to the shuttle 2. The legs 32 can contact the plate 21 and support the cover 3 in areas where no sample holders 10 are located, maintaining a desired orientation and position of the cover 3 relative to the shuttle 2. In some cases, a cover 3 may be configured to latch or otherwise engage or connect with a shuttle 2, e.g., so that the cover 3 is locked or held in place relative to the shuttle 2 unless the latch or other engagement feature is disengaged. This may allow, for example, a robotic gripper to grasp the cover 3 only and pick up the cover 3 along with an attached shuttle 2 and sample holders 10 engaged with the cover 3. As an example, the cover 3 may include a latch including an arm that is pivotally mounted to the cover 3 at a pivot axis. The latch arm may have a lower end below the pivot axis that is positionable adjacent a shuttle 2 on which the cover 3 is placed, e.g., so the lower end of the latch arm is adjacent a portion of the gripper walls 27 of the shuttle 2. The lower end of the latch arm may have a hook that extends inwardly from the lower end of the latch arm and is engageable with an opening or other surface of the gripper wall 27. An upper end of the latch arm may extend above the pivot axis, e.g., a part of the upper end of the latch arm may extend to a location adjacent the gripper wall 37 of the cover 3. The latch arm may be spring biased to pivot about the pivot axis so that the lower end of the latch arm is biased to move inwardly toward the gripper wall 27 of the shuttle 2 and the upper end of the latch arm is biased to move away from the gripper wall 37 of the cover 3. Thus, if the cover 3 is placed on the shuttle 2, the hook on the lower end of the latch arm may engage with the opening or other feature of the gripper wall 27 of the shuttle 2 under the spring bias so that the cover 3 is coupled to the shuttle 2. This engagement may allow the cover 3 to be picked up, e.g., by a robotic gripper that grips the gripper walls 37, and the cover 3 may support the shuttle 2 so the shuttle 2 moves with the cover 3. To disengage the cover 3 from the shuttle 2, the upper end of the latch arm may be moved inwardly toward the cover 3 so that the hook on the latch arm disengages from the shuttle 2. This can be done, for example, by a robotic gripper gripping or otherwise contacting the upper end of the latch arm so the upper end is moved inwardly against the spring bias to disengage the lower end from the shuttle 2. This allows the cover 3 to be removed from the shuttle 2. Note that latch arms may be provided on opposed sides of the cover 3, e.g., extending downwardly from both gripper walls 37 so that the shuttle 2 may be engaged in areas at or near both gripper walls 27. Other arrangements for removably engaging a cover 3 and shuttle 2 are possible.

Another feature shown in FIG. 4 is that the cover 3 can include alignment features 31 in the form of one or more protrusions, e.g., frustoconical elements, that depend downwardly from a lower surface of the cover 3. The alignment features 31 may engage with respective caps 11 or other portions of a sample holder 10 to help hold the holder 10 in place and/or align the holder 10 with respect to the shuttle 2. As an example, the frustoconical alignment features 31 in FIG. 4 can engage with recesses 14 in caps 11 of sample holders 10 so that the sample holders 10 are suitably aligned in directions along a plane of the plate 21 (e.g., horizontally) and/or in directions perpendicular to the plane of the plate 21 (e.g., vertically).

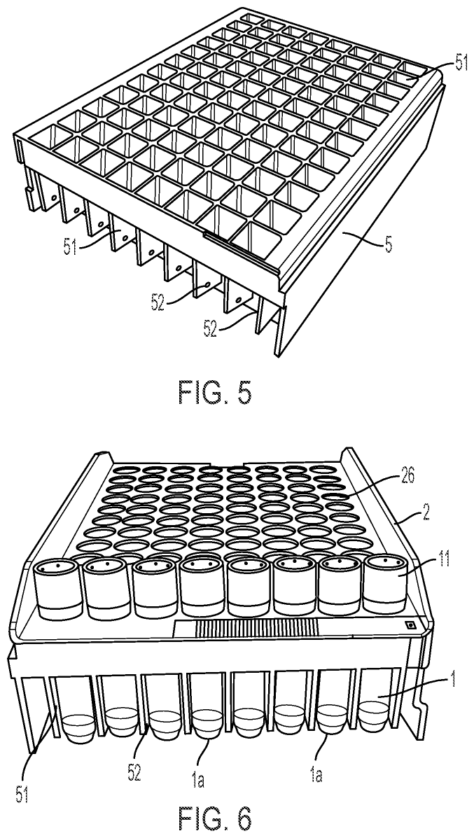

FIG. 5 shows a tube rack 5 that may be used to receive sample holder vessels 1 held by a shuttle 2 in some embodiments. The tube rack 5 in FIG. 5 is only one of many possible components that may receive sample holders 10 held by a shuttle 2, including an acoustic treatment system 100 as in FIG. 2, a PCR thermocycler, etc. A tube rack 5 can be employed for multiple purposes, such as supporting a shuttle 2 and associated sample holders 10 when sample holders 10 are loaded onto the shuttle 2, assisting in automated capping/decapping of sample holder vessels 1, and others. For example, in some cases a tube rack 5 can include multiple cavities 51 each for receiving a corresponding vessel 1. Each cavity 51 may include one or more tabs 52 or other engagement features to engage with a corresponding vessel 1 received in the cavity 51, e.g., as shown in FIG. 6. In some cases, vessels 1 may include one or more fins 1a or other engagement features configured to engage with a tab 52 or other engagement feature in a cavity 52 of a tube rack 5. Engagement of the vessel fins 1a with a tab 52 (or other engagement features) can help resist rotation of the vessel 1 more than a specific amount in a cavity 52, e.g., rotation of the vessel 1 more than 30 to 90 degrees may be resisted. Thus, a cap 11 on a vessel 1 may be engaged, e.g., by an automated capper/decapper, so that the cap 11 can be rotated relative to the vessel 1 for removal of the cap 1 from the vessel 1 and/or engagement of the cap 11 with the vessel 1.

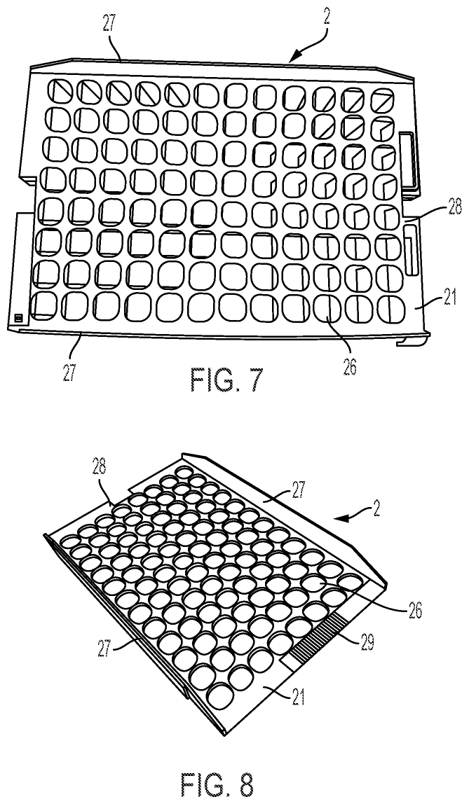

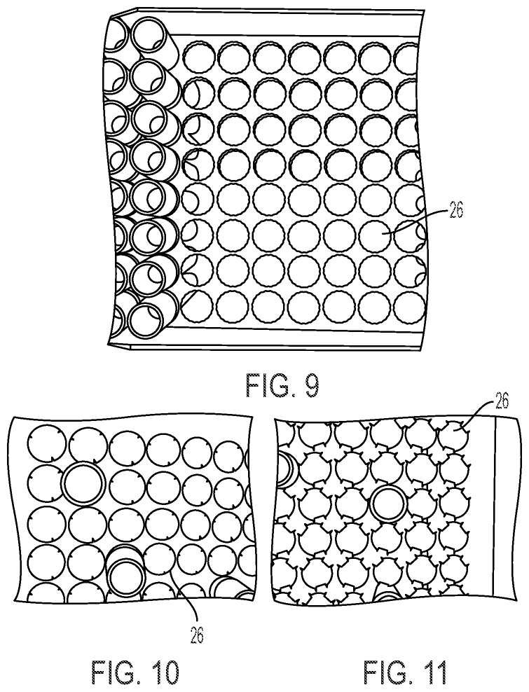

While in some embodiments sample holder vessels 1 may be received into opening 26 of a shuttle 2 so that the vessels 1 can be relatively easily removed from the opening 26 (e.g., by lifting in a vertical direction) and/or rotated about a longitudinal or vertical axis while held in the opening 26 of a shuttle 2, a shuttle 2 may be configured to engage with vessels 1 so that the vessels 1 cannot be easily removed from the opening 26 and/or rotated about a longitudinal or vertical axis. Such engagement may be useful, for example, in ensuring vessels 1 do not disengage from a shuttle 2, do not rotate relative to the shuttle 2 (e.g., for automated capping/decapping purposes), and/or do not move vertically or along a longitudinal axis (e.g., when a relatively light vessel 1 is immersed in a water bath of an acoustic treatment system and the vessels 1 “float” upwardly relative to the shuttle 2). FIGS. 7 and 8 show a shuttle 2 including openings 26 configured to engage with sample holder vessels 1 so that the vessels are locked in place relative to the shuttle 2 when received in the opening 26. Thus, engagement of the vessels 1 with the shuttle 2 at the opening 26 may prevent rotation of the vessel 1 relative to the shuttle 2 about a vertical axis (or axis perpendicular to the plate 21) and/or movement of the vessel 1 along the vertical axis relative to the plate 21. In some embodiments, the openings 26 may have an oval or elongated shape, e.g., such that two opposed portions of the opening 26 along a minor axis define a partial circular shape with a radius that is smaller than a radius of a cylindrical portion of a vessel to be received in the opening 26 and two other opposed portions of the opening along a major axis are configured to avoid contact with the vessel received at the opening 26. The opposed portions that define a partial circular shape are configured to engage with the cylindrical portion of the vessel so that the vessel is squeezed and potentially deformed between the opposed wall portions. This strongly engages the vessel with the opposed circular wall portions, preventing rotation and/or longitudinal movement of the vessel 1 relative to the shuttle 2. Of course, the opening 26 configuration in FIGS. 7 and 8 is only one possible arrangement and others can be employed for the same purposes. For example, FIG. 9 shows openings 26 of a shuttle 2 having a circular shape with toothed or serrated features extending around the opening. The toothed or serrated features are configured to engage with the vessel wall, e.g., causing the vessel to deform and/or the tooth/serration features to cut into the vessel wall to prevent rotation and/or longitudinal movement of the vessel relative to the shuttle 2. FIG. 10 shows an arrangement in which openings 26 have a generally circular shape with three spikes or triangular protrusions extending radially inwardly from the opening wall. The spikes or triangular protrusions are configured to cut into the vessel wall and/or cause the vessel wall to deform when the vessel is engaged at the opening. FIG. 11 shows another arrangement in which the openings have a generally circular shape with generally rectangular shaped tabs extending radially inwardly from the opening wall. These tabs, like the teeth, serrations or spikes, are configured to cut into the vessel wall and/or cause the vessel wall to deform when the vessel is received to firmly engage the vessel with the shuttle 2.

While aspects of the invention have been described with reference to various illustrative embodiments, such aspects are not limited to the embodiments described. Thus, it is evident that many alternatives, modifications, and variations of the embodiments described will be apparent to those skilled in the art. Accordingly, embodiments as set forth herein are intended to be illustrative, not limiting. Various changes may be made without departing from the spirit of aspects of the invention.

1. A sample holder shuttle for holding one or more sample holders for laboratory processing, the shuttle comprising:
a plate including first and second opposed edges, third and fourth opposed edges, and a plurality of openings each configured to receive and hold a respective sample holder such that a lower portion of the sample holder depends from a bottom side of the plate and is exposed for receiving acoustic energy to treat a sample in the sample holder;
first and second gripper walls extending upwardly from a top side of the plate at the first and second opposed edges, respectively, the first and second gripper walls being configured to engage with a robotic gripper and support the plate and sample holders received at the plurality of openings; and
a first notch extending inwardly from the third edge configured to align a cover with respect to the plate.

2. The sample holder shuttle of claim 1, wherein the plurality of openings are configured in a symmetrical rectangular array.

3. The sample holder shuttle of claim 1, wherein the plurality of openings are configured to engage with a rim of a sample holder such that portions of the sample holder below the rim hang from the plate.

4. The sample holder shuttle of claim 1, further comprising a plurality of sample holders each configured as a tube with a lower portion and an upper portion, the upper portion configured to engage with a part of the plate near a respective one of the plurality of openings to support the tube such that the lower portion depends from the plate.

5. The sample holder shuttle of claim 1, wherein the first and second gripper walls each include gripping surfaces configured to engage with the robotic gripper that face outwardly and away from the plate.

6. The sample holder shuttle of claim 5, wherein the gripping surfaces are perpendicular to a plane of the plate.

7. The sample holder shuttle of claim 1, wherein the first and second gripper walls each include gripping surfaces including an anti-slip feature configured to engage with the robotic gripper.

8. The sample holder shuttle of claim 7, wherein the anti-slip feature includes a surface roughness, a resilient pad, or groove.

9. The sample holder shuttle of claim 1, wherein the first notch has surfaces that are parallel to the first and second edges.

10. The sample holder shuttle of claim 1, further comprising an RFID tag configured to identify a source of the shuttle or a compatibility of the shuttle.

11. The sample holder shuttle of claim 1, further comprising a cover configured to extend over at least a portion of plate to cover the plurality of openings, the cover including an alignment feature configured to engage with the first notch to align the cover with the plate.

12. The sample holder shuttle of claim 11, further comprising a second notch extending inwardly from the fourth edge, wherein the cover includes first and second alignment features configured to engage with a respective one of the first and second notches to align the cover with the plate.

13. The sample holder shuttle of claim 12, wherein the first and second alignment features each includes a wedge including opposed sides arranged at an angle relative to each other and configured to engage with a corresponding surface of the respective notch.

14. The sample holder shuttle of claim 13, wherein the first and second notches each have surfaces that are parallel to the first and second edges and are configured to engage with a respective side of a respective one of the wedges.

15. The sample holder shuttle of claim 1, further comprising a cover configured to extend over at least a portion of plate to cover the plurality of openings, the cover configured to press downwardly on one or more sample holders received at the plurality of openings.

16. The sample holder shuttle of claim 15, wherein the cover is configured to be supported relative to the plate by the one or more sample holders, the cover configured to have a mass sufficient to urge the one or more sample holders into engagement with the plate to orient the one or more sample holders relative to the plate.

17. The sample holder shuttle of claim 16, wherein each of the one or more sample holders includes a radially extending flange that is positioned on the plate adjacent the opening in which the sample holder is received, and wherein force of the cover on the one or more sample holders urges the flange into contact with the plate to orient the sample holder relative to the plate.

18. The sample holder shuttle of claim 15, further comprising a plurality of sample holders each configured as a tube with a lower portion and an upper portion, the upper portion configured to engage with a part of the plate near a respective one of the plurality of openings to support the tube such that the lower portion depends from the plate, and wherein the cover is configured to engage with each of the plurality of sample holders to urge the plurality of sample holders into contact with the plate.

19. The sample holder shuttle of claim 18, wherein each of the plurality of sample holders includes a cap covering an opening at the upper portion of the sample holder, and wherein the cover is configured to engage with the cap to urge the sample holder into contact with the plate.

20. The sample holder shuttle of claim 19, wherein each cap includes a recess and the cover includes a plurality of protrusion each configured to engage with the recess of a corresponding cap of a sample holder.

21. The sample holder shuttle of claim 1, further comprising a plurality of sample holders each configured as a tube with a lower portion, an upper portion and an internal volume extending from an opening at the upper portion to the lower portion, the upper portion configured to engage with a part of the plate near a respective one of the plurality of openings to support the tube such that the lower portion depends from the plate, and the plurality of sample holders configured to hold a sample in the internal volume for treatment by focused acoustic energy.

22. The sample holder shuttle of claim 1, wherein the plurality of openings are each configured to engage with a sample holder received at the opening to lock the sample holder in place relative to the shuttle.

23. The sample holder of claim 22, wherein the openings are configured to engage with the sample holder to prevent rotation about and movement along a longitudinal axis of the sample holder relative to the shuttle.

24. A sample holder assembly for holding one or more sample holders for laboratory processing, the assembly comprising:
a shuttle having a plate including a plurality of openings each configured to receive and hold a respective sample holder such that a lower portion of the sample holder depends from a bottom side of the plate and is exposed for receiving acoustic energy to treat a sample in the sample holder.

25. The assembly of claim 24, further comprising:
a cover configured to extend over at least a portion of plate to cover the plurality of openings, the cover configured to press downwardly on one or more sample holders received at the plurality of openings.

26. The assembly of claim 25, wherein the cover is configured to be supported relative to the plate by the one or more sample holders, the cover configured to have a mass sufficient to urge the one or more sample holders into engagement with the plate to orient the one or more sample holders relative to the plate.

27. The assembly of claim 24, wherein the plurality of openings are each configured to engage with a sample holder received at the opening to lock the sample holder in place relative to the shuttle.

28. The assembly of claim 27, wherein the openings are configured to engage with the sample holder to prevent rotation about and movement along a longitudinal axis of the sample holder relative to the shuttle.
